(19) United States
(12) Patent Application Publication
(10) Pub. No.: US 2006/0150813 A1
(43) Pub. Date: Jul. 13, 2006

(54) Process and plant for ultrapurifying fumes or gasses

(76) Inventor: Valerio Tognazzo, Abano Terme (IT)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 10/528,832

(22) PCT Filed: Sep. 26, 2003
(86) PCT No.: PCT/EP03/10753

§ 371 Date: Mar. 23, 2005

(30) Foreign Application Priority Data
Oct. 1, 2002 (IT) VE2002A000030

(51) Int. Cl. B01D 47/00

(52) U.S. Cl. 95/228

(57) ABSTRACT

A process for ultrapurifying fumes or gases with total recovery of the resultant pollutants, characterised by: subjecting a stream of pollutant-containing fumes or gases to a sprinkle wash by unpolluted water within a snow producer (20) and subjecting the water, during its passage, to rapid cooling to a temperature sufficient to transform it into snow flakes, which along their path collect the pollutants present in the stream of fumes or gases, discharging from said snow producer (20) said snow flakes which have reached the base thereof, and feeding to a gasifier the resultant polluted water deriving from said snow flakes.

The present invention relates to a process and a plant for ultrapurifying fumes or gases with total recovery of the resultant pollutants.

The atmosphere is well known to contain a considerable level of pollutant fumes and gases produced by ex-waste dumps (biogas), gasifiers, power stations, waste incinerators, etc. and containing micropollutants consisting mainly of particles of diameter less than 1 μm (fine particulate) which have been shown by epidemiological studies to cause illness and death.

The most obvious and dangerous example is that of waste incinerators, which generally consist of a large air-fed combustion chamber operating at about 900° C. followed by a small post-combustion chamber operating at about 1200° C., and are able to transform the waste feed into mainly fine particles, into CO₂, into H₂O, etc.

Subsequent purification of the fumes with filters, also known as dry purification, is unable to effectively remove micropollutants in particular, whereas wet purification, which would be more effective, can no longer be used because discharge of polluted effluent water into the environment is forbidden.

Consequently although current waste incinerators solve the general problem of thermal destruction, they have not yet satisfactorily solved the problem of eliminating micropollutants. In particular, the fumes emitted by an incinerator contain dangerous micropollutants originating essentially from two sources: metals and organochlorine compounds (dioxins and furans). These latter are difficult to remove as only a small percentage (about 20%) becomes attached to dust or other easily removable solid particles present in the fumes, whereas the remainder are in the vapour state (aerosol) and particularly dangerous because on coming into contact with water or other liquids they are not removed, but instead are transported by them.

In particular the organochlorine compounds constitute very dangerous environmental pollutants as they are able to develop a teratogenic and carcinogenic activity and in addition harm the immune, endocrinic and reproductive systems. They are also bioaccumulable, i.e. they are able to accumulate along the alimentary chain, becoming always more dangerous with time.

Because of these serious problems which such pollutants are able to cause, the problem exists of removing them to the greatest possible extent, the object of the present invention therefore being to propose a method and plant for use downstream for example of any dry purification plant, to solve this problem.

Another object is to remove from gases, prior to their use, any pollutants which result in corrosion, wear, blockage, incrustation and other highly damaging consequences.

The aforesaid problem is solved according to the invention by a process for ultrapurifying fumes or gases with total recovery of the resultant pollutants, as described in claim 1.

The invention also foresees a plant for implementing the process as described in claim 32.

A preferred embodiment of the present invention is described in detail hereinafter with reference to the accompanying drawings, in which:

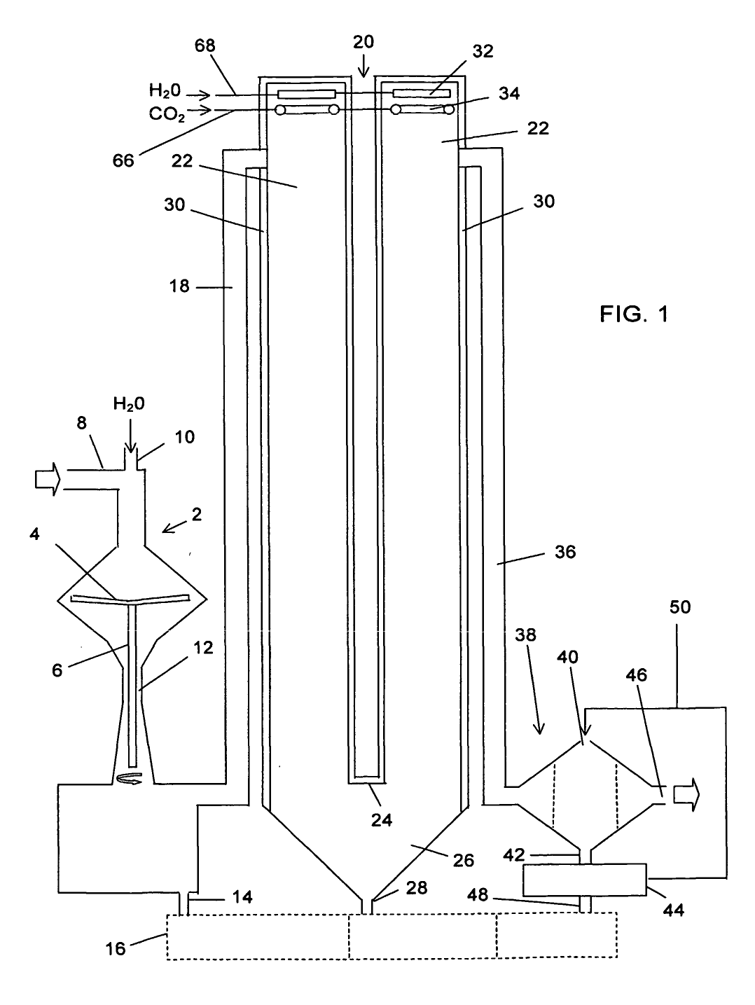

FIG. 1 shows schematically a plant for implementing the process of the invention, and

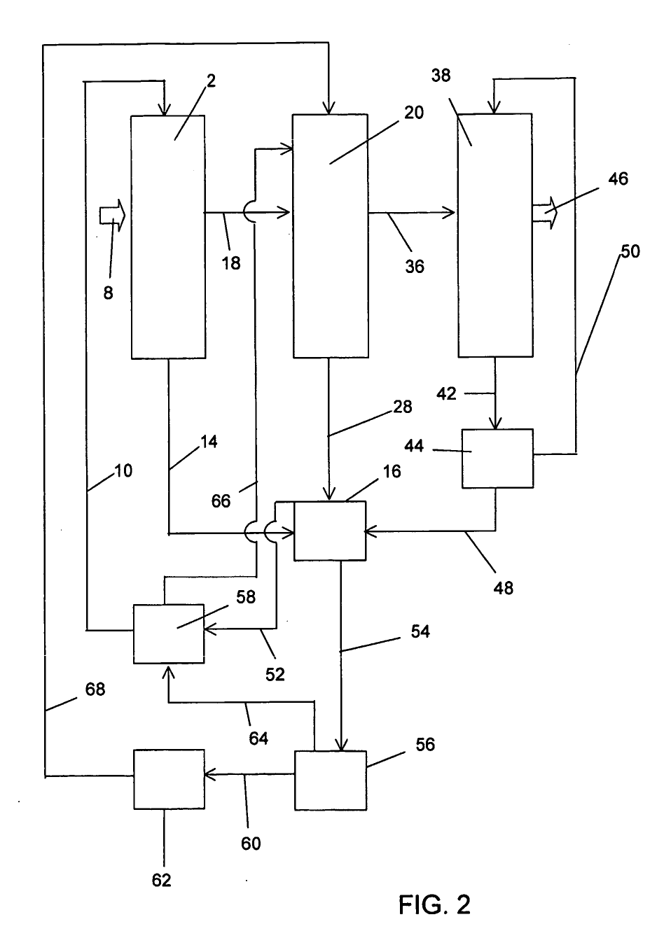

FIG. 2 shows a block diagram of the operation of the plant connected to external purification and gasification plants integrated with a system of fuel cells.

As can be seen from the figures, the ultrapurification plant of the invention is installed downstream of any purifier, for example of traditional type, which uses dry purification systems, possibly associated with equipment, for example a scrubber (not shown), to reduce the fume temperature to ambient (about 20-30° C.).

In its essential lines it comprises a washer 2, consisting essentially of a vessel of double frusto-conical shape, the interior of which contains, at the level of the connection between the two major bases, a slightly upwardly concave plate 4 supported by a shaft 6 rotatable about its vertical axis at high speed, preferably not less than 1000 r.p.m.

The top of the vessel forming the water 2 is connected via a conduit 8 to the scrubber from which the fumes or gases to be treated originate, and via another short conduit 10 to the water jet feed at a temperature of about 4° C.

The lower part of the double-cone vessel 2 presents a constriction 12 able to determine a venturi effect, below this it being connected via a conduit 14 to a traditional water purifier 16. The washer is also connected via another conduit 18 to a snow wash chamber 20 (snow producer), fed at the top with unpolluted water.

The snow producer consists essentially of two side-by-side cylindrical vessels 22 of vertical axis connected together at their lower end by a horizontal conduit 24 having a conical lower part 26 and provided at its lowest point with a discharge conduit 28 towards the water purifier 16. Each cylinder 22 comprises a heat-insulating covering 30 on its outer surface and is provided upperly, below its roof, with a shower disc 32 fed by a conduit 68 for feeding unpolluted water. In a position below each shower disc 32 there is provided a perforated ring 34 fed by a conduit 66 for feeding CO₂ at a temperature substantially less than 0° C.

One of the two cylinders 22 receives in its upper part, a short distance from its upper edge, the conduit 18 connected to the washer 2, the other cylinder 22 receiving in its upper part a conduit 36 connected to an activated carbon filter 38.

This filter 38 consists of a vessel provided not only with the lateral connection opening to the conduit 38 for entry of the fume or gas stream, but also with an upper opening 40 for activated carbon entry, a lower discharge conduit 42 towards an underlying dryer 44, and a lateral opening 46 for discharging the completely purified fumes or gases.

From the activated carbon dryer 44 there extends a conduit 48 for discharging to the water purifier 16 the water which is generated during the activated carbon drying process. Traditional conveyors, indicated schematically in the drawings by a conveying line 50, are also provided for transferring the dried activated carbon from the dryer 44 to the upper opening 40 of the filter 38.

Due to the different features of pollution of the waters coming out from the washer 2, snow wash chamber 20 and dryer 44, it may be foreseen that the purifier 16 consists of several different purifiers, each suitable to treat the above polluted waters in a more reliable way.

As stated, in the plant of the invention not only the discharge conduit 14 from the washer 2 but also the discharge conduit 28 from the snow producer 20 and the discharge conduit 48 from the activated carbon dryer 44 are connected to the water purifier 16, which for example comprises an evaporator providing purified exit steam along a conduit 52 and resultant polluted water along another conduit 54.

The water purifier 16 is connected by the conduit 54 to a gasifier 56, consisting advantageously of the machine the subject of EP-B1-0292987, entitled “Method and machine for transforming pollutant or waste combustible materials into clean energy and usable products”, able to dissociate the water and recover the hydrogen.

The conduit 52 leaving the purifier 16 enters a heat exchanger 58 and leaves as the conduit 10, which feeds the washer 2 with ice-cold water.

The gasifier 56 is connected via a conduit 60 to a fuel cell system 62 for its feeding with H₂ and via another conduit 64 to the heat exchanger 58 for its feeding with liquid CO₂, and from there, via the conduit 66, to the perforated rings 34 of the cylinders 22 of the snow producer 20.

The fuel cell system 62 is connected via the conduit 68 to the sprinkler discs 32 of the cylinders 22 of the snow producer 20, for its feeding with unpolluted water.

The plant of the invention is also provided with a plurality of systems for the control, monitoring and adjustment of all the operative parameters, in particular of the fluid temperatures and flow rates. As these systems can be considered traditional and hence within the capacity of the expert of the art, they are not further described.

The aforedescribed plant operates in the following manner:

the fumes and gases to be treated and from which macropollutants have already been removed are fed into the washer 2, together with the jet of ice-cold water originating from the heat exchanger 58 and fed from above via the conduit 10. Within the washer 2 the water strikes the plate 4 which, by virtue of its rotation, propels it at high speed by centrifugal effect against the facing lateral wall of the washer, this wall being grazed internally by the fumes or gases containing the micropollutants.

The effect of the hurling of said fumes or gases against the wall of the washer 2 by the water flow, which is at its maximum density, combined with the reduction in the cross-section of their passage through the annular gap bounded by the rotating plate 4 and said wall of the washer 2, causes the water to incorporate a large part of the pollutants. This incorporation is facilitated if the angle formed by the direction of said centrifugal water jet and the fume or gas flow direction is less than 90°.

The subsequent annular constriction 16 traversed by the water/fume or gas mixture pressurizes the system by the venturi effect, to enhance this incorporation.

The resultant polluted water is discharged from the washer 2 through the conduit 14 and transferred to the purifier 16, where it is treated.

The thus pretreated fumes or gases containing the micropollutants in a considerably smaller quantity leave the washer 2 and pass through the conduit 18 to enter the snow producer 20. Here, on encountering the flow of cold CO₂ originating from the heat exchanger 58 and fed through the conduit 66 into the snow producer 20 from above, the unpolluted water, obtained by hydrogen combustion in the fuel cells 62, in accordance with the already stated EP-B1-0292987, is transformed into snow flakes by virtue of the low temperature of said CO₂. These, while descending along the two cylinder vessels 22 forming said snow producer, encounter the stream of fumes or gases in co-current and in counter-current along the labyrinth path, to pick up the water containing the pollutants, so increasing their volume, and the pollutants not contained in the water.

According to the invention the water can be transformed into snow flakes in other ways, for example by cooling the snow producer 20 with a CO₂ stream directed onto the outside of the walls of the cylinder vessels 22, or by using a different cold gas, for example nitrogen, or oxygen later used as combustion support in the gasifier 56.

It should be noted that the seizure effect of the snow flakes and the reduced kinetics of the micropollutants, due to the low temperature at which their removal takes place, determine the optimum conditions for seizure with high operative yield, both of the water containing pollutants and of those pollutants not contained in the water. The effect of the snow flakes is to be considered similar to that of the activated carbon, with the additional capacity of removing types of pollutants not removable by activated carbon.

At the exit of the snow producer 20 the fume or gas flow is virtually free of any trace of water, which because of the low temperature has undergone freezing, with growth of the snow flakes. This flow of fumes or gases undergoes heating to above 0° C. during its passage through the conduit 36 both because of the length of this conduit and because of the possible presence of heating means therealong. At the end of its path the heated fume or gas stream enters the filter 38 containing activated carbon at a temperature exceeding 0° C., and travels downwards from the top to soak up any water which has not been taken up in the snow producer 20. As a result of this the activated carbon becomes moist and is regenerated in the dryer 44, from which it is returned to the cycle through the conveying line 50.

In an advantageous embodiment of the invention, the heat required to dry the activated carbon is provided by the plant which produces the fumes or gases to be purified or, in particular, by the gasifier 56.

The water leaving the dryer 44 is fed through the conduit 48 to the purifier 16 where it is subjected to a traditional purification process in a like manner to the water leaving the washer 2 and the snow producer 20.

After successive regeneration cycles, when the activated carbon is spent it can be fed to the gasifier 56 for its thermal destruction.

Because of the triple purification stage effected in the washer 2, in the snow producer 20 and in the activated carbon filter 44, the fume or gas flow leaving this filter through the opening 46 is totally free of any trace of pollutants.

It should be noted that the washer 2, which absorbs the pollutants in an optimum manner on the basis of the two principles of centrifugal force and venturi pressure effect, exercises a powerful reduction on the pollutants contained in the fumes or gases. However these will inevitably entrain at the exit of the washer 2 a small quantity of water containing micropollutants. The subsequent snow producer 20 has the capacity to lock onto the snow flakes the water which has emerged from the washer 2 and hence the micropollutants contained in them, to hence achieve a more thorough purification. The subsequent activated carbon filter 38 totally removes the minimal traces of water containing micropollutants which may have escaped the effect of the snow flakes, so completing purification.

The aforedescribed ultrapurification plant is advantageously used together with a gasifier according to the said EP-B1-0 292 987. For this purpose the purified steam leaving the purifier 16 is fed through the conduit 52 to the heat exchanger 58, while the resultant polluted water leaving the purifier 16 is fed to the gasifier 56 in which it is transformed into H₂ and liquid CO₂.

The liquid CO₂ is fed through the conduit 64 to the heat exchanger 58, in which it undergoes partial heat transfer with the steam from the purifier 16, to condense it and transform it into water at 4° C. The CO₂, now heated but still at a temperature below 0° C., is fed through the conduit 66 to the perforated rings 34 of the snow producer 20, while the ice-cold water obtained by condensing the steam is fed through the conduit 10 into the washer 2.

The hydrogen from the gasifier 56 is fed through the conduit 60 to the fuel cell system 62, by which usable energy and unpolluted water are generated. This latter is fed through the conduit 68 to feed the sprinkler discs 32 of the snow producer 20.

The final result of the thus integrated process of the invention is hence the total purification of the fumes or gases and the production of energy by the fuel cell system 62, with considerable environmental and economical advantages.

It should also be noted that in general the gases leaving the gasification plant of EP-B1-0 292 987 contain acids (hydrochloric acid, sulphuric acid, etc.) which the various traditional purification systems are unable to remove completely, even though their purification costs are very high.

These acids, dissolved in the residual process water, rapidly decompose the metal-based catalysts generally used to convert carbon monoxide (CO) and water (H₂O) into carbon dioxide (CO₂) and hydrogen (H₂). These acids also contaminate the carbon dioxide obtained, making it unusable, hence leading to high economical losses. Finally these acids have damaging effects on integrated gasifier-fuel cell plants, where a very high purity of the fuel gas used to generate electrical energy (with high efficiency), heat and unpolluted water is essential.

Consequently the application of the present invention is very advantageous for the gasification plant of EP-B1-0 292 987.

The gasification plant of EP-B1-0 292 987, when used for example to thermally destroy plastic, has in practice a minimum capacity of 2 t/h and is able to produce:
14,700 m³/h of gas to be subjected to ultrapurification treatment,
9.5 MW in excess, to be used for evaporating the discharge water from the ultrapurification plant, to hence recycle it,
12 MW of electrical energy for use in operating the washer, etc.,
7300 kg/h of CO₂ at −40° C. (in addition to H₂ and/or O₂ and/or N₂) for cooling water and gas and for obtaining snow,
1100 l/h of unpolluted water, obtained by total recovery of the pollutants fed into the gasifier, for snow production.

Although these quantities are obtained from a very small quantity of thermally destroyed plastic material, they are much higher than required for operating the ultrapurification plant of the present invention; it follows that integrating this ultrapurification plant with a gasifier in accordance with EP-B1-0 292 987 enables the waste products of this latter to be used not only for feeding the former plant, but also for feeding other ultrapurification plants to remove pollutants produced by other types of plant (for example incinerators, cement factories, etc.).

1. A process for ultrapurifying fumes or gases with total recovery of the resultant pollutants, comprising:
subjecting a stream of pollutant-containing fumes or gases to a sprinkle wash by unpolluted water within a snow producer and subjecting the water, during its passage, to rapid cooling to a temperature sufficient to transform it into snow flakes, which along their path collect the pollutants present in the stream of fumes or gases,
discharging from said snow producer said snow flakes which have reached the base thereof, and
feeding the resultant polluted water deriving from said snow flakes to a gasifier.

2. A process as claimed in claim 1, further comprising feeding an ascending stream of fumes or gases into said snow producer.

3. A process as claimed in claim 1, further comprising subjecting the stream of gases or fumes to the action of the snow flakes within said snow producer along at least one portion of their path in co-current and along at least one portion of their path in counter-current.

4. A process as claimed in claim 1, further comprising using, for the wash, unpolluted water provided by fuel cells fed with hydrogen produced by said gasifier.

5. A process as claimed in claim 1, further comprising cooling the wash water to a temperature not greater than 0° C.

6. A process as claimed in claim 1, further comprising rapidly cooling the wash water by cooling the snow producer.

7. A process as claimed in claim 6, further comprising cooling said snow producer with a stream of cold fluid circulating externally along the walls of the snow producer.

8. A process as claimed in claim 1, further comprising rapidly cooling said unpolluted water with a stream of cold gas injected into said snow producer.

9. A process as claimed in claim 7, further comprising cooling said snow producer with oxygen used as combustion support in the gasifier.

10. A process as claimed in claim 8, further comprising rapidly cooling the wash water with a stream of carbon dioxide.

11. A process as claimed in claim 8, further comprising rapidly cooling the wash water with a stream of nitrogen.

12. A process as claimed in claim 1, further comprising passing the stream of fumes or gases, already subjected to the action of the snow flakes, through dry activated carbon.

13. A process as claimed in claim 12, further comprising drying the activated carbon with heat obtained from a thermal destruction plant.

14. A process as claimed in claim 12, further comprising drying the activated carbon with heat generated by the plant which produces the stream of fumes or gases to be purified.

15. A process as claimed in claim 12, further comprising feeding to a gasifier the resultant polluted water obtained by drying the activated carbon.

16. A process as claimed in claim 12, further comprising feeding the spent activated carbon to a thermal destruction plant.

17. A process as claimed in claim 1, further comprising subjecting the stream of gases or fumes to washing before subjecting the stream of gases or fumes to the action of the snow flakes, after which the resultant polluted water is fed to the gasifier.

18. A process as claimed in claim 17, further comprising washing the stream of fumes or gases by striking said stream with a water jet at high speed.

19. A process as claimed in claim 18, further comprising washing the stream of fumes or gases with a water jet forming an angle less than 90° to the direction of said stream of fumes or gases.

20. A process as claimed in claim 18, further comprising impressing high speed onto the water jet by making it fall from above onto a plate rotating about a vertical axis.

21. A process as claimed in claim 17, further comprising washing the stream of fumes or gases with water at a temperature of about 4° C.

22. A process as claimed in claim 21, further comprising obtaining the wash water at a temperature of about 4° C. by cooling with cold gas.

23. A process as claimed in claim 21, further comprising obtaining the wash water at a temperature of about 4° C. by cooling with gas from the gasifier.

24. A process as claimed in claim 22, further comprising cooling the wash water with carbon dioxide.

25. A process as claimed in claim 22, further comprising cooling the wash water with nitrogen.

26. A process as claimed in claim 22, further comprising cooling the wash water with oxygen.

27. A process as claimed in claim 17, further comprising washing the stream of fumes or gases in a washer having at least one wall grazed by said stream.

28. A process as claimed in claim 17, further comprising feeding the polluted discharge water to a purification plant before feeding to the gasifier.

29. (canceled)

30. A process as claimed in claim 28, further comprising condensing the steam generated by the purification plant by means of liquid CO₂ produced by the gasifier to obtain water with which the washer is fed.

31. A process as claimed in claim 1, further comprising using the hydrogen produced by the gasifier to feed fuel cells, from which unpolluted water is obtained to feed the snow producer.

32. A plant for ultrapurifying fumes or gases with total recovery of the resultant pollutants comprising:
a snow producer fed with the stream of fumes or gases to be purified and also fed with unpolluted water,
cooling means associated with said snow producer, to transform said water into snow flakes,
at least one exit conduit having an outlet, said exit conduit extending from said snow producer for the stream of purified fumes or gases, and
means for connecting the base of said snow producer to a gasifier for the resultant polluted water deriving from said snow flakes.

33. A plant as claimed in claim 32, wherein the stream of fumes or gases within said snow producer is ascending.

34. A plant as claimed in claim 32, wherein the snow producer is shaped to provide at least one portion through which the stream of fumes or gases takes a descending path and at least one portion through which it ascends.

35. A plant as claimed in claim 32, wherein the base of said snow producer is of conical shape.

36. A plant as claimed in claim 34, wherein the snow producer comprises at least two vessels of substantially vertical extension, connected together to define a labyrinth path for the stream of fumes or gases.

37. A plant as claimed in claim 32, wherein the walls of the snow producer are heat insulated.

38. A plant as claimed in claim 32, wherein the snow producer is provided upperly with means for the sprinkling delivery of said unpolluted water.

39. A plant as claimed in claim 32, wherein the snow producer is provided upperly with a plurality of nozzles for delivering a stream of cold gas.

40. A plant as claimed in claim 32, wherein the snow producer is provided upperly with at least one perforated ring fed with cold gas.

41. A plant as claimed in claim 32, wherein the walls of the snow producer are provided with at least one interspace for circulating a stream of cold gas.

42. A plant as claimed in claim 32, wherein the outlet for the stream of fumes or gases from the snow producer is connected via a conduit to an activated carbon filter.

43. A plant as claimed in claim 42, wherein the characteristics of said conduit are chosen to enable the stream of fumes or gases to be heated as it flows therethrough.

44. A plant as claimed in claim 42, wherein said conduit is provided with heating means.

45. A plant as claimed in claim 42, wherein a dryer for regenerating activated carbon is associated with the activated carbon filter, together with a conveyor line for said carbon regenerated within said filter.

46. A plant as claimed in claim 45, wherein said dryer is connected to said gasifier.

47. A plant as claimed in claim 45, wherein said dryer is connected to a thermal destruction plant for providing the heat necessary for the dryer operation.

48. A plant as claimed in claim 32, further comprising a washer provided upstream of said snow producer for preliminary treatment of the stream of fumes or gases to be purified.

49. A plant as claimed in claim 48, wherein said washer consists of a circular vessel provided internally with a rotating plate, the edge of the rotating plate and the wall of said vessel define an annular passage for the mixture of said fumes or gases fed into said vessel, with the wash water, the wash water made to fall from the top of said vessel onto said rotating plate.

50. A plant as claimed in claim 49, wherein the rotating plate presents a slight upwardly facing concavity.

51. A plant as claimed in claim 49, wherein said vessel is of double conical form, with the central part of major diameter positioned at the height of said rotating plate.

52. A plant as claimed in claim 48, wherein said washer is connected to said gasifier via a conduit.

53. A plant as claimed in claim 35, further comprising a purifier fed with the discharge waters and connected to said gasifier.

54. A plant as claimed in claim 53, wherein said purifier comprises an evaporator with an exit for steam and another exit for resultant polluted water, which feeds said gasifier.

55. A plant as claimed in claim 53, further comprising a heat exchanger having a cooling circuit and a cooled circuit, the cooling circuit fed with CO₂ originating from said gasifier and is connected to said snow producer, the cooled circuit being fed with steam originating from said purifier and being connected to said washer.

56. A plant as claimed in claim 32, further comprising a fuel cell system fed with hydrogen from said gasifier and which feeds said snow producer with unpolluted water.

57. A plant as claimed in claim 45, wherein the gasifier is connected to the dryer to provide the heat necessary for operating the dryer.
